(19) United States
(12) Patent Application Publication
(10) Pub. No.: US 2002/0014159 A1
(43) Pub. Date: Feb. 7, 2002

(54) Adsorbent, adsorption column and apparatus for pressure swing adsorption separation

(75) Inventors: Yasuo Tatsumi, Tokyo (JP); Masato Kawai, Tokyo (JP)

Correspondence Address: Merchant & Gould P.C., P.O. Box 2903, Minneapolis, MN, 55402-0903, US

(73) Assignee: Nippon Sanso Corporation

(21) Appl. No.: 09/858,267

(22) Filed: May 15, 2001

(30) Foreign Application Priority Data
Jun. 27, 2000 (JP) 2000-192303

(51) Int. Cl. B01D 53/02

(52) U.S. Cl. 96/130; 95/96; 502/400

(57) ABSTRACT

There is provided a size and a shape capable of decreasing an unit power consumption, an adsorption column having the optimal shape for the selected adsorbent, and a pressure swing adsorption separation apparatus having an excellent pressure swing adsorption separation performance. In the present invention, an adsorbent having an equivalent diameter within a range of 1.0±0.2 mm or within a range from 12 mesh to 20 mesh is used and the adsorption column is established such that a superficial velocity u [m/s] of a raw material air is set to be within a range of ±25% of u=0.07a +0.095 to the equivalent diameter a [mm].

### BACKGROUND OF THE INVENTION

1. Field of the Invention

The present invention relates to an adsorbent, an adsorption column and an apparatus for pressure swing adsorption separation process, more specifically to an optimal size of the adsorbent to be used for separating and collecting an objective component gas from a multi-component gas mixture by the pressure swing adsorption separation process, such as oxygen from air, a shape of the adsorption column capable of carrying out the pressure swing adsorption separation process in an optimal condition according to the size of the adsorbent, and a pressure swing adsorption separation apparatus using the adsorption column.

2. Description of the Prior Art

The major operation for separating and collecting an objective component gas from a multi-component gas mixture as a raw material gas by pressure swing adsorption (PSA) separation process, generally comprises an adsorption process consisting of pressurizing and then introducing a raw material gas into an adsorption column packed with an adsorbent, and bringing the raw material gas into contact with the adsorbent, thereby selectively adsorbing more adsorptive component in the raw material gas, as well as separating and collecting the less adsorptive component, and a regeneration process consisting of regenerating the adsorbent by depressurizing the pressure of the adsorption column and desorbing the more adsorptive component from the adsorbent which adsorbs the adsorptive component.

The above regeneration operation process can be divided mainly into two types; i.e., a process by depressurizing the adsorption column to a pressure below the atmospheric pressure (vacuum regeneration process) and a process by depressurizing the adsorption column to a pressure around the atmospheric pressure (atmospheric regeneration process). The adsorption operation in the vacuum regeneration process is frequently carried out in a pressure condition relatively close to the atmospheric pressure in order to decrease the compression power of the raw material gas and thus, it is appropriate for generating a large amount of product gas. On the other hand, in the atmospheric regeneration process, since the regeneration operation is carried out at the atmospheric pressure, it is necessary to set the adsorption pressure high such that the difference between the adsorption pressure and the atmospheric pressure may be sufficient. Furthermore, since a vacuum pump or a product gas compressor is not required even though the compression power of the raw material gas becomes large, the process is frequently employed for generating a small amount of product gas. In particular, when the raw material gas is to be air and the product gas is to be oxygen, there is much availability in the case where it is preferable for a small amount of product oxygen to have a little pressure in view of supply, such as for medical use or the like.

In addition, the apparatus construction to be used in the pressure swing adsorption separation apparatus is provide with a raw material gas compressor, at least one adsorption column, product reservoir, and if required, a vacuum pump for regenerating the adsorbent or a product gas compressor, as well as a piping system in accordance with the separation process which links the above respective elements. Furthermore, in the pressure swing adsorption separation apparatus, by using a controller such as a computer or a sequencer, to output electrical signals according to the program of the separation process which has been input in advance, and to control the on/off of the automatic switching valve and repeating the above described adsorption/regeneration operation, the product gas is separated and collected.

As for the adsorbent used in such a pressure swing adsorption separation process, since in such a case of obtaining oxygen as product gas from air, the objective component to be adsorbed and removed is nitrogen, zeolite is used as the adsorbent for selectively adsorbing nitrogen. As for the zeolites, for example, Ca-A type, Na-X type, Ca-X type, Ba-X type are preferred. Recently, a zeolite in which Na ion of Na-X type is exchanged with various ions, in particular a zeolite of Li-X type where Na ion is exchanged with Li ion, is largely used.

In addition, as for a general designing method of a pressure swing adsorption separation apparatus, there is A. I. LaCava et al.'s reference, CHEMICAL ENGINEERING/JUNE 1998, pp. 110-118. The reference explains the designing method of the pressure swing adsorption separation apparatus in detail. However, it reads that since the development of the pressure swing adsorption separation process has been started from experiments by small scale apparatuses and the performance obtained from the experiments on a small scale is generally higher than that from an industrial scale apparatus, one of the methods to avoid the above risk is to construct a middle size of a pilot apparatus. Furthermore, it also describes that ┌the column height of the pilot apparatus must be the same as the required practical size of the apparatus. The size is generally about 2 m┘. As described in the above reference, in the designing method of a general adsorption column, the size of the adsorption column of the practical apparatus is determined as follows.

At first, by selecting the adsorbent to be used and then carrying out an experiment in a small size apparatus and an experiment in a pilot apparatus, the product amount per the unit weight (or volume) of the used adsorbent is obtained. Next, if the product amount required in the practical apparatus is divided by the amount of the generated product per the above amount of the adsorbent, the required weight (or volume) of the adsorbent is obtained. Then, If the packing height of the adsorption column is set to be the same as that of the experiment, from the relationship of ┌the weight of adsorbent=the packing volume of the adsorbent X the packing density of the adsorbent┘, the diameter of the adsorption column is obtained. From the above method, apparatus designing by the pressure swing adsorption separation processes using with many kinds of adsorbents, was carried out in the past.

In addition, the shapes of the adsorbents to be used are also various. In particular, as for the particle diameter of the adsorbent, 1/16 inch or ⅛ inch of pellets, or 8-12 mesh of beads or the like are generally adopted, while the adsorbents having smaller particle diameters are also used. In general, in case of using a large particle diameter of the adsorbent, the pressure drop of the adsorbent packed layer is small, however, as the diffusion path of the adsorbed molecules into the adsorbent becomes longer, the total mass transfer coefficient becomes smaller.

On the other hand, in case of using relatively smaller adsorbent particles, the pressure drop of the adsorbent packed layer is large, however, the mass transfer coefficient tends to become larger. The pressure drop of the adsorbent packed layer results in requiring large power for supplying a raw material air. Furthermore, since the magnitude of the mass transfer coefficient relates to the so-called Mass Transfer Zone, it has a relationship with the required adsorbent amount. Furthermore, in case of performing vacuum regenerating, the pressure difference between the upper section and the lower section of the adsorption column is generated, which causes such a problem that the regenerated degree of the adsorbent becomes different at each position inside the adsorption column.

For that reason, though it has been an important issue how to decide the size and shape of the particles of the adsorbent to be used, with respect to how to select and use the adsorbent having the various sizes and shapes, there has been no quantitative guide. Therefore, it has been broadly studied a designing method for a more effective adsorption apparatus, that is, a method capable of minimizing the amount of the adsorbent to be used and improving the performance of the pressure swing adsorption separation apparatus, in particular, a method for an apparatus which is excellent in unit power consumption.

For example, BUNRI GIJUTSU vol.11. No 5. p11-17(1981) proposed a combination of a small particle diameter adsorbent and a large particle diameter adsorbent, by instancing a removal of water from gas. In this case, it is described that by arranging a large particle diameter adsorbent in the upstream side and a small particle diameter adsorbent in the downstream side respectively, the pressure drop in the upstream side as well as the width (length) of the mass transfer zone in the downstream side can be reduced. That is, the above method aims to solve such opposite problems of the adsorbents having the respective particle diameters, that the pressure drop is small but the required amount of the adsorbent is large in case of using only the large particle diameter adsorbent, and the pressure drop is large but the required amount of the adsorbents is small in case of using only the small particle diameter adsorbent, by combining and harmonizing the small particle diameter adsorbent and the large particle diameter adsorbent. However, with regard to the thickness of the adsorbent layer, it only shows the Ergun's formula relating to the pressure drop of the packing layer and simply indicates that the void ratio of the packing layer, are important as well as the diameter of the adsorbent, without suggesting how to accumulate the large particle diameter adsorbents and the small particle diameter adsorbents for minimizing the power consumption.

On the other hand, referring to many examples disclosing the particle diameter of the adsorbent to be used and the thickness of the adsorbent layer as well as the cycle time of the pressure swing adsorption separation operation corresponding to the above particle diameter from the patents relating to the conventional pressure swing adsorption separation process as a prior art, the Japanese laid-open publication Hei 11-179132 indicates that as for the particles having the same diameter, the thickness of the respective layers are very different one another, which makes it difficult to select, and the geometrical constrains imposed by the dead volume within the adsorption column is not considered.

In addition, the publication states that there is provided a pressure swing adsorption separation process where the thickness of the adsorbent layer is substantially dependant only on the diameter in case of the adsorbent having a spherical shape, and there is no minus effect on the energy consumption of the pressure swing adsorption separation process by considering the geometrical constrains from the dead volume. Furthermore, the above publication discloses the relationship between the particle size of the adsorbent and the thickness of the adsorbent layer, and shows proper ranges of the adsorbent layer and the particle size of the adsorbent. However, the variables of the obtained relationship are two, and even if the particle diameter is determined, layer thickness which seems to be usually used within a range of inequality is merely disclosed broadly and there is no such description that the particle having the diameter has the best performance.

In addition, with regard to designing an adsorption column used in the pressure swing adsorption separation process, the kind of the adsorbent to be used is selected from those commercially available from the adsorbent makers by considering the static/dynamic adsorption performance. However, with respect to such problems that which particle diameter can increase the apparatus performance most i.e., which particle diameter can lower the unit power consumption as a particle diameter of the adsorbent used in the pressure swing adsorption separation apparatus for collecting oxygen, under which gas flow velocity such an adsorbent should be used and how high the packing height should be, since there was no means but to determine the above mentioned problems based on experiments as disclosed in the above LaCava and the like's reference, a technical improvement has been required.

In this circumstance, the inventors studied the shape and the size of the adsorbent which can reduce the unit power consumption to the lowest, by establishing the unit power consumption as an index of the pressure swing adsorption separation apparatus whose product is oxygen and varying the particle shape or size of the adsorbent in many ways. As a result, it was found that a specific particle size of the adsorbent can decrease the unit power consumption to the lowest.

Furthermore, it was made clear that there exists the optimal shape of the adsorption column to the adsorbent having various shapes and sizes i.e., the optimal gas superficial velocity to the adsorbent shape characteristic. Moreover, it was found that the superior performance of the pressure swing adsorption separation to that of the conventional one is obtained by determining the diameter of the adsorption column on the basis of the shape characteristic of the selected adsorbent.

The objective of the present invention which is completed on the above knowledge and experience, is to provide the size and shape of the adsorbent for separating and collecting an objective component gas from a multi-component gas mixture by the pressure swing adsorption separation process, and in particular capable of collecting oxygen as product from air by the pressure swing adsorption separation process and decreasing the unit power consumption, the adsorption column having the optimal shape for the selected adsorbent, and the pressure swing adsorption separation apparatus having an excellent pressure swing adsorption separation performance.

### SUMMARY OF THE INVENTION

To accomplish the above objective, the first construction of an adsorbent for a pressure swing adsorption separation, to be used for separating and collecting an objective component gas from a multi-component gas mixture by the pressure swing adsorption separation process, the adsorbent comprises: particles having a size wherein the size of the particles of the adsorbent is established such that a diameter in case of the particles of the adsorbent having a spherical shape, or an equivalent diameter in case of the particles of the adsorbent having a cylindrical shape, an elliptic spherical shape or an elliptic cylindrical shape is set to be within a range of 1.0±0.2 mm.

Furthermore, according to the second construction of an adsorbent for a pressure swing adsorption separation, the particles of the adsorbent having a particle diameter distribution within a range from 12 mesh to 20 mesh are contained at least more than 70% in the adsorbent when the particle diameter distribution of the particles of the adsorbent is measured by a tyler standard sieve.

According an adsorption column of the present invention for a pressure swing adsorption separation column packed with an adsorbent for separating and collecting an objective component gas from a multi-component gas mixture by a pressure swing adsorption separation process, the adsorption column comprises: the adsorbent comprising particles having a size wherein the size of the particles of the adsorbent is established such that a diameter in case of the particles of the adsorbent having a spherical shape, or an equivalent diameter in case of the particles of the adsorbent having a cylindrical shape, an elliptic spherical shape or an elliptic cylindrical shape, is supposed to be a [mm], and a superficial velocity u[m/s] is set to be within a range of ±25% of u=0.07a+0.095 and in particular, an adsorbent to be used is the adsorbent for a pressure swing adsorption separation of the present invention. Furthermore, the pressure swing adsorption separation apparatus of the present invention uses the above-mentioned adsorption column. In particular, the present invention is most suitable to the case where the multi-component gas mixture is air and the objective component gas is oxygen. As the adsorbent, one of a Ca-A type zeolite, a Na-X type zeolite or a zeolite where at least a part of Na of the Na-X type zeolite is ion-exchanged by Ca, Mg or Li, can be properly used. Furthermore, it is more preferable when the pressure swing adsorption separation process includes a vacuum regeneration process.

### BRIEF DESCRIPTION OF THE DRAWING

For fuller understanding of the nature and objects of the present invention, reference should be made to the following detailed description taken in conjunction with the accompanying drawings in which:

FIG. 1 is a systematic diagram showing a PSA apparatus as an object of the simulation according to the present invention;

FIG. 2 is a drawing showing an example of the PSA process according to the present invention;

FIG. 3 is a drawing showing the relationship between the superficial velocity of the raw material air and the ratio of the unit power consumption;

FIG. 4 is a drawing showing the relationship between the particle equivalent diameter and the superficial velocity of the raw material air where the unit power consumption becomes the minimum value; and

FIG. 5 is a drawing showing the relationship between the obtainable minimum value of the unit power consumption and the equivalent diameter of the adsorbent particle.

### DETAILED DESCRIPTION OF THE INVENTION

In this case, the pressure swing adsorption separation process is an unsteady process that the pressure, temperature, gas flux and gas composition in an adsorption column complicatedly vary with the time, and a dynamic simulation as well as an experiment is effective for grasping the apparatus performance. Hereinafter, the present invention will be described by means of the dynamic simulation in the following.

In the NIPPON SANSO ENGINEERING REPORT No.17, p18-24 (1998) discloses a simulation method for a pressure swing adsorption separation process in which oxygen is made to be a product (hereinafter, referred to as “oxygen PSA”). In this case, the objective oxygen PSA is two-column type, and the process thereof consists of pressurization/product collecting step, pressure equalization step, vacuum regeneration step, purge regeneration step and pressure equalization step, in which the theoretical model is set up under the several hypotheses. In addition, the basic equation is composed of total mass balance, the mass balances of the respective components, the adsorption rate equation, the equilibration adsorption amount estimation equation and the heat balance equation, etc.

Furthermore, the material balance is obtained by making the airflow discharge pressure and/or the vacuum pump-reached vacuum degree as controlling factors, such that the air blower feed amount for supplying the raw material air is made equal to the sum of the amount of the product gas and the amount of the discharge gas from the vacuum pump for regenerating the adsorbent. According to the material balance, the condition of the motor attached to the pressure swing adsorption separation apparatus (PSA apparatus) is determined and thus, the amount of the electric power required for the rotator is obtained and consequently, the unit power consumption which is one of the most important performances for the PSA apparatus is obtained.

By putting the relational expression between the particle size and the mass transfer coefficient in the particle as an adsorbent characteristic (Kagaku Kogaku, 31.4. 354-358 (1967)) into the above simulator, the particle size of the adsorbent and the adsorption rate were made to be related each other.

In addition, since the adsorbent particle size is believed to be a factor directly influencing the unit power consumption, by applying the Ergun's formula to the adsorbent packing layer, the pressure loss of the height direction of the packing layer due to varying the adsorbent particle size to be packed was calculated, and by obtaining the adsorption pressure/regeneration pressure in the respective heights in the adsorption column, the influences to the amount of the product oxygen and the power consumption were computed.

By using the above simulator, at first, with respect to a vacuum-regeneration type PSA apparatus (VGA), under predetermined conditions of air blower amount, vacuum pump capacity and the adsorbent amount to be used, the particle size of the adsorbent to be used was determined and then, by varying the diameter of the adsorption column diameter, the amount of the oxygen having the specified concentration (for example, 93% O₂) was obtained. If the sum of the power consumptions of the air blower and the vacuum pump is divided by the amount of the product oxygen gas, the unit power consumption is obtained. The adsorption column diameter when the unit power consumption becomes the minimum value becomes the most advantageous adsorption column diameter for the particle diameter of the adsorbent.

On the other hand, from the above calculation, the raw material air amount as a raw material air to be supplied to the PSA apparatus can be obtained. In this case, the value which is obtained by converting the amount of the raw material air to the standard condition (0° C., 1 atm the absolute pressure) and by dividing it by the sectional area of the adsorption column, is defined as superficial velocity. By varying the particle diameter of the adsorbent to be used and then, calculating as above described, the optimum superficial velocity corresponding to the respective adsorbent particle diameter is obtained.

Furthermore, as for designing the PSA apparatus, by carrying out a predetermined PSA operation from experiments or simulations, the oxygen recovery ratio and the oxygen generation amount per the unit amount of the adsorbent are obtained. That is to say, as for the required amount of oxygen for the practical apparatus (the reduced amount of pure oxygen), the shape (column diameter) of the adsorption column can be determined by the following calculations:

required amount of the raw material air=(reduction of pure oxygen) required amount of oxygen/(oxygen recovery ratio x oxygen content in air)

required amount of adsorbent=the required amount of the raw material air/generation amount per the adsorbent unit amount

sectional area of the adsorbent column=the required amount of the raw material air/the superficial velocity

packing height of the adsorbent=the required amount of the adsorbent/(packing density×the sectional area of the adsorption column).

Furthermore, the oxygen recovery ratio is based on the amount of oxygen contained in the raw material air.

In the present invention, the adsorbent particle diameter means a diameter for a spherical particle, and an equivalent diameter for the other shapes. For example, in case of a cylindrical (pellet shape) adsorbent having a diameter d and a height h, the formula becomes of surface area/volume=(2d+4h)/(d×h). According to the above formula, in case the adsorbent is a sphere having an equivalent diameter a,

surface area/volume=6/a=(2d+4h)/(d×h) leads to a=3d×h/(d+2h).

The above relationship is described in Fundamentals of Adsorption. Proceedings of the Engineering Foundation Conference held at Schloss Elmau, Bavaria, West Germany, (1983) p49. However, the equivalent diameter adopted in the present invention is not limited to this, but includes a diameter obtained by a simple method, such as a peak value or an average value of the particle diameter distribution or the like.

In addition, it was obtained such a conclusion that the adsorbent of the present invention can be optimized to the most preferred value of the original unit, when the adsorbent having 1 mm of a diameter or an equivalent diameter is used by calculating the above diameter and the equivalent diameter with the above simulator and by relating the pressure loss and the value of the mass transfer coefficient in the adsorbent having generally used shape and size, such as ⅛ inch, 1/16 inch of pellet shape, or 8-12 mesh of beads shape. Furthermore, the above conclusion suggests that the process is not related and shows that by obtaining the optimal superficial velocity, deriving the relationship between the shape and size of the selected adsorbent and the superficial velocity, and determining the diameter of the adsorption column based on the above relationship, the PSA performance in the apparatus for separating and collecting oxygen gas from air using PSA process can be improved in comparison with the conventional apparatus.

### DESCRIPTION OF THE PREFERRED EMBODIMENTS

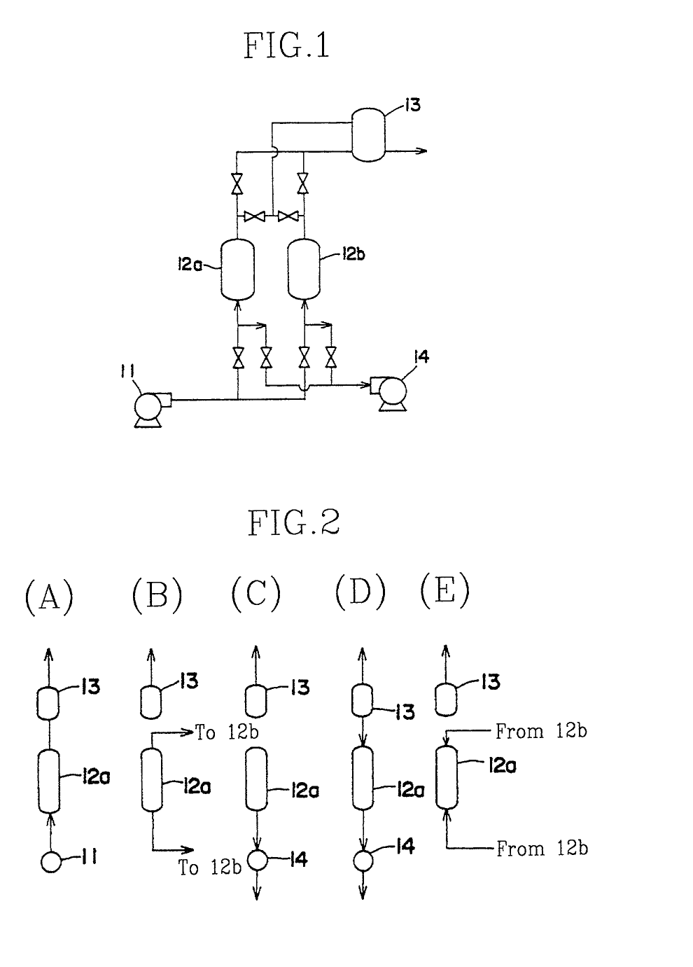

FIG. 1 is a systematic diagram showing a PSA apparatus as an object of the above simulation. Though It shows a 2-column type PSA apparatus, it is needless to say that the apparatus of the present invention is not limited to this.

The 2-column type PSA apparatus shown in FIG. 1 comprises raw material air blower 11, two adsorption columns 12a, 12b, a surge tank 13, a vacuum pump 14, an adsorbent packed in the respective adsorption columns 12a, 12b, a related piping (including valves) and a controlling apparatus. The airflow is simply explained as follows. The air in the atmosphere is pressurized up to 500-5000 mmAq(4900-49030 Pa) by the raw material air blower 11 and introduced into one of the adsorption columns 12a, 12b, for example, into the adsorption column 12a. In the adsorption column 12a, impurities such as water and nitrogen gas are adsorbed by the adsorbent and the oxygen difficult to be adsorbed is discharged from the top of the adsorption column 12a. The discharged oxygen gas is delivered to the surge tank 13 and a part thereof is discharged as a product, while the residue thereof is used for gas-purging the other adsorption column 12b under regeneration or for repressurizing the adsorption column 12b after regeneration. On the other hand, the gas adsorbed by the adsorbent is desorbed by depressurising the inside of the adsorption column with the vacuum pump 14, thereby the adsorbent is regenerated. The discharged gas is exhausted from the vacuum pump 14.

FIG. 2 shows an example of the PSA process according to the present apparatus. As the PSA process, many other processes not limited to this, can be used. If the process of FIG. 2 is explained as a representative example, the object 2-column type PSA process comprises (A) repressurization/product recovery step, (B) pressure equalization step, (C) vacuum regeneration step, (D) purge regeneration step, and (E) pressure equalization step. The respective processes will be explained focusing on the adsorption column 12a which is one of the two columns.

(A) In the repressurization/product recovery step, the raw material air supplied from the raw material air blower 11 is introduced from the lower section of the adsorption column 12a, and ascends in the adsorption column 12a, while the impurities such as water, carbon dioxide and nitrogen are adsorbed and removed. Then, the oxygen gas is discharged from the top of the adsorption column 12a and collected as a product via the surge tank 13.

(B) In the pressure equalization step, the introduction of the raw material air into the adsorption column 12a and collection of the product from the adsorption column 12a are once stopped. Then, the gas of the adsorption column 12a is delivered to the other adsorption column 12b from both the upper section and the lower section of the adsorption column 12a simultaneously.

(C) In the vacuum regeneration step, the gas in the column is delivered to the vacuum pump 14 from the bottom of the adsorption column 12a, so that the adsorption column 12a is depressurized and regenerated.

(D) In the purge regeneration step, when the above vacuum regeneration process reaches a predetermined vacuum degree, a part of oxygen collected from the surge tank 13 is introduced from the top of the adsorption column 12a, while continuing the depressurization by the vacuum pump 14.

(E) In the pressure equalization step, when the above purge regeneration finishes, the gas flow is conversed to that of the pressure equalization step (D), and the gas from the other adsorption column 12b is introduced from the top and bottom of the adsorption column 12a. In addition, when the pressure of the adsorption column 12a rises up to a predetermined pressure in which the pressure equalization is completed, the process returns to the adsorption step (A) and the raw material air is introduced from the bottom of the adsorption column 12a. Then, when the adsorption column 12a is pressurized up to the predetermined pressure, the product begins to be discharged from the top of the adsorption column 12a to the surge tank 13.

By repeating the respective processes alternatively as for both of the adsorption columns 12a, 12b, the product oxygen gas can be collected continuously. Though the switching condition of the respective step was described with the pressure in the above explanation, time can also be used for the condition.

In carrying out the present simulation, it was supposed that the adsorption columns 12a, 12b are respectively packed with activated alumina for adsorbing water in the side of the raw material air introduction end and X-type zeolite, which is highly ion-exchanged by Li, for adsorbing and separating nitrogen in the downstream. The packing volumes of the respective adsorbents were about 0.4 m³ for the activated alumina, and about 2.2 m³ for zeolite, which are made constant in the respective calculations. The other PSA operation conditions are shown in the following.

| cycle time | 82 | sec |
|---|---|---|
| repressurization/product recovery step | 37 | sec |
| pressure equalization step | 4 | sec |
| vacuum regeneration step | 27 | sec |
| purge regeneration step | 10 | sec |
| pressure equalization step | 4 | sec |
| raw material air temperature | 300 | K |
| product oxygen purity | 93.0% | |
| purge gas flow rate | 160 | Nm³/h |

In addition, the parameters used in the calculation are shown in the following. Furthermore, as for the accuracy of the calculation, the time integral was conducted with every 0.1 sec, by using calculation lattice and equal spacing lattice of 0.01 m of lattice length.

Composition of the raw material air

| | |
|---|---|
| water vapor | 0.5% |
| nitrogen | 77.7% |
| oxygen | 20.9% |
| argon | 0.9% |
| heat transfer coefficient between wall and packing layer | 1.0 W/(m² · K) |

| | |
|---|---|
| activated alumina | zeolite |

| | | | | |
|---|---|---|---|---|
| packing amount | 320 | kg | 1400 | kg |
| packing density | 784 | kg/m³ | 644 | kg/m³ |
| void rate | 0.4 | | 0.37 | |
| heat capacity | 1050 | J/(kg · K) | 920 | J/(kg · K) |

In addition, the number of cycles until the PSA operation reaches a steady state was set to about 2000, and the performance of the apparatus in the steady state was established to be the result of the simulation.

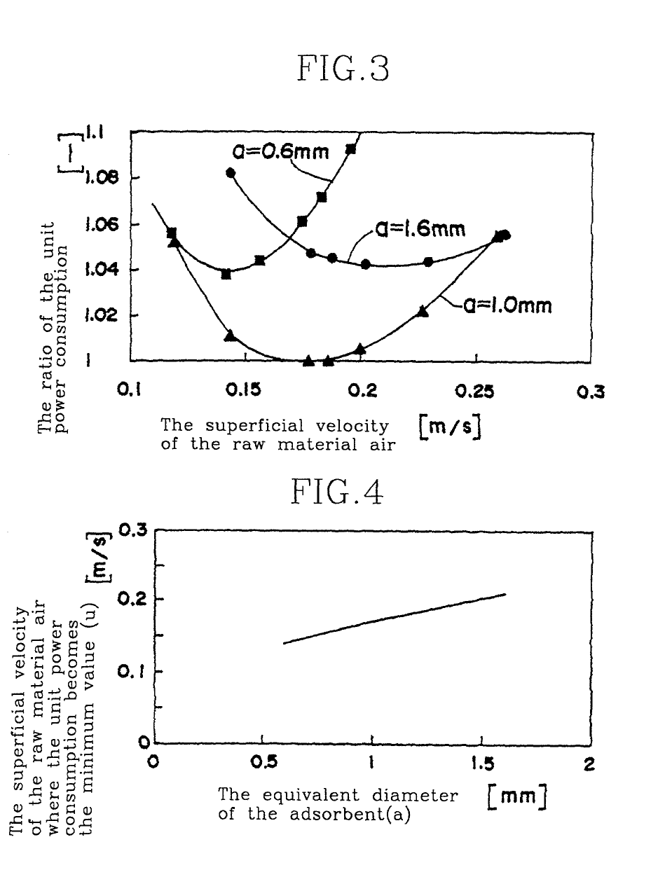

First of all, with regard to the three kinds of the equivalent particle diameters of the adsorbent particle a i.e. 0.6 mm, 1.0 mm and 1.6 mm the adsorbent particle, the change of the unit power consumption when the superficial velocity of the raw material air was varied was obtained. From the obtained results, the ratio of the unit power consumption was calculated based on the minimum value of the unit power consumption in case the equivalent diameter was 1.0 mm. The relationship between the ratio of the unit power consumption and the superficial velocity u of the raw material air is shown in FIG. 3.

Next, from FIG. 3, the respective particle equivalent diameter a and the superficial velocity u of the raw material air where the unit power consumption with respect to the above respective particle equivalent diameter a became the minimum value, were obtained. Then, the relationship between the adsorbent particle equivalent diameter a and the superficial velocity u of the raw material air where the unit power consumption became the minimum value was produced. The result is shown in FIG. 4.

From FIG. 4, the relationship between the equivalent diameter a of the adsorbent and the superficial velocity u of the raw material gas where the unit power consumption became the minimum value, can be extrapolated in a straight line, and it can be expressed in the following formula.

u=0.07a+0.095

In addition, from FIG. 3, in order that the ratios of the unit power consumption to the respective particle equivalent diameter a may be set to be within the range of about 3% as the allowable rising range from the minimum value of the unit power consumption, the upper and lower limits of the superficial velocity U are designated as follows.

0.75u*U*1.25u

However, the above allowable range means only the economically allowable range, and does not mean the absolute limitation.

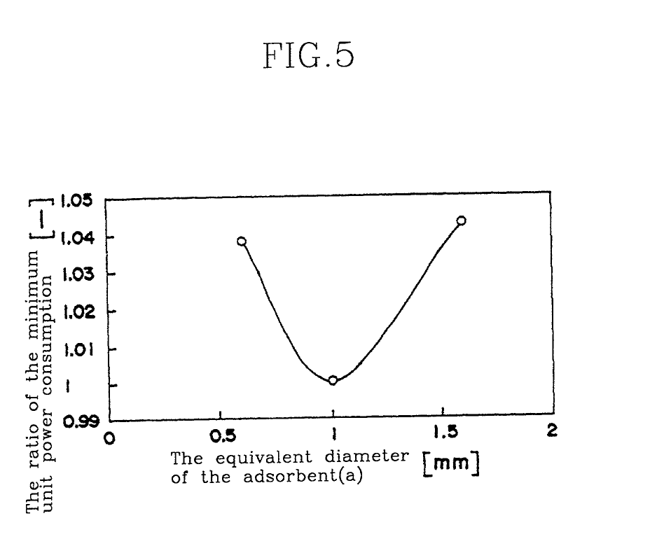

From the results, it can be understood that there exists the optimal raw material air superficial velocity corresponding to the equivalent diameter a of the adsorbent particle. In addition, the relationship between the minimum value of the unit power consumption and the equivalent diameter a of the adsorbent particle is shown in FIG. 5.

As apparent from FIG. 5, when the equivalent diameter a of the adsorbent particle is 1 mm, it was understood that the unit power consumption of the oxygen PSA apparatus shows its minimum value.

The adsorbent having the shape of a generally available adsorbent particle, in particular, bead shape has a particle diameter distribution and is composed of a mixture of the large and small particle diameters. In the apparatus in which the particle diameter of the adsorbent can become a problem, the adsorbent is marketed after being subjected to a sieve-grading process such that the particle diameter distribution thereof has a peak value in case of a specific particle diameter.

In the present invention, since the unit power consumption of the PSA apparatus is minimized by using an adsorbent having a specific equivalent diameter (including diameter) as an adsorbent for PSA apparatus, it is preferred that the above peak of the diameter distribution exists within a specific range of values.

In addition, the diameter distribution of the adsorbent is measured by using a sieve such as a tyler standard sieve. However, according to the scale of the sieve to be used, the particles within the range of less than 14 mesh and more than 16 mesh have approximately 1 mm of diameter. Generally, if the particle diameters are selected from such a narrow range, the commercially available amount becomes decreased. Thus, it is conducted to allow the sieve to have some degree of width such that the amount of the particles in the above range (for example, weight %) is to be more than a predetermined ratio.

As for the adsorbent of the present invention, the adsorbent is used whose particles within a range of less than 12 mesh and more than 20 mesh when 1 mm is set as a standard, account for the 70 wt % of the total amount. The higher percentage than the above percentage is more advantageous. However, in case of the smaller percentage, i.e., when relatively more amount of larger or smaller particles is contained, the desired minimum value of the unit power consumption as the performance of the PSA apparatus, cannot be obtained.

In addition, when the mesh scales of the sieves are converted into dimensions, 20 mesh corresponds to 0.833 mm and 12 mesh corresponds to 1.397 mm. about 1±0.2 mm can be permitted as for the particle diameter. If an expression is adopted by the above described particle distribution, the amount of the adsorbent particles having the diameter or the equivalent diameter in the range of 1±0.2 mm can be said to be at least 70% of the total amount of the adsorbent.

As described above, according to the present invention, it is possible to minimize the unit power consumption of the PSA apparatus by using the adsorbent having a specified diameter, an equivalent diameter or a specified mesh range. Furthermore, it is possible to improve the performance of the PSA by forming the adsorbent column such that a specified relationship for the adsorbent is to be established.

What is claimed is:

1. An adsorbent for a pressure swing adsorption separation, to be used for separating and collecting an objective component gas from a multi-component gas mixture by said pressure swing adsorption separation process, said adsorbent comprising:
particles having a size
wherein said size of said particles of said adsorbent is established such that a diameter in case of said particles of said adsorbent having a spherical shape, or an equivalent diameter in case of said particles of said adsorbent having a cylindrical shape, an elliptic spherical shape or an elliptic cylindrical shape is set to be within a range of 1.0±0.2 mm.

2. An adsorbent for a pressure swing adsorption separation, to be used for separating and collecting an objective component gas from a multi-component gas mixture by said pressure swing adsorption separation process, said adsorbent comprising:
particles
wherein said particles of the said adsorbent having a particle diameter distribution within a range from 12 mesh to 20 mesh are contained at least more than 70% in said adsorbent when said particle diameter distribution of said particles of said adsorbent is measured by a tyler standard sieve.

3. The adsorbent according to claim 1 or 2, wherein said multi-component gas mixture is air and said objective component gas is oxygen.

4. The adsorbent according to claim 1 or 2, wherein said adsorbent is one of a Ca-A type zeolite, a Na-X type zeolite or a zeolite where at least a part of Na of said Na-X type zeolite is ion-exchanged by Ca, Mg or Li.

5. The adsorbent according to claim 1 or 2, wherein said pressure swing adsorption separation process includes a vacuum regeneration process.

6. An adsorption column for a pressure swing adsorption separation column, packed with an adsorbent for separating and collecting an objective component gas from a multi-component gas mixture by a pressure swing adsorption separation process, said adsorption column comprising:
said adsorbent comprising particles having a size
wherein said size of said particles of said adsorbent is established such that a diameter in case of said particles of said adsorbent having a spherical shape, or an equivalent diameter in case of said particles of said adsorbent having a cylindrical shape, an elliptic spherical shape or an elliptic cylindrical shape, is supposed to be a [mm], and a superficial velocity u[m/s] is set to be within a range of ±25% of u=0.07 a+0.095.

7. The adsorption column according to claim 6, wherein said diameter a or said equivalent diameter a of said adsorbent is in a range of 1.0±0.2 mm.

8. The adsorption column according to claim 6, wherein said particles of said adsorbent having a particle diameter distribution within a range from 12 mesh to 20 mesh are contained at least more than 70% in said adsorbent when said particle diameter distribution of said particles of said adsorbent is measured by a tyler standard sieve.

9. The adsorption column according to claim 6, wherein said multi-component gas mixture is air and said objective component gas is oxygen.

10. The adsorption column according to claim 6, wherein said adsorbent is one of a Ca-A type zeolite, a Na-X type zeolite or a zeolite where at least a part of Na of said Na-X type zeolite is ion-exchanged by Ca, Mg or Li.

11. The adsorption column according to claim 6, wherein said pressure swing adsorption separation process includes a vacuum regeneration process.

12. A pressure swing adsorption separation apparatus, said apparatus provided with said adsorption column according to one of claims 6 to 11.
